(19) United States
(12) Patent Application Publication
(10) Pub. No.: US 2016/0335963 A1
(43) Pub. Date: Nov. 17, 2016

(54) DISPLAY PANEL AND DRIVING METHOD FOR THE SAME

(71) Applicant: Shenzhen China Star Optoelectronics Technology Co. Ltd., Shenzhen, Guangdong (CN)

(72) Inventors: Jingjing WU, Shenzhen, Guangdong (CN); Zhi XIONG, Shenzhen, Guangdong (CN)

(73) Assignee: Shenzhen China Star Optoelectronics Technology Co. Ltd., Shenzhen, Guangdong (CN)

(21) Appl. No.: 14/761,091

(22) PCT Filed: May 20, 2015
(86) PCT No.: PCT/CN2015/079368

§ 371 Date: Jul. 15, 2015

(30) Foreign Application Priority Data
May 12, 2015 (CN) 2015102397049

(51) Int. Cl. G09G 3/36; G09G 3/34

(52) U.S. Cl. CPC G09G 3/3607; G09G 3/3677; G09G 3/3688; G09G 3/3413; G09G 2310/08

(57) ABSTRACT

A display panel and a driving method for the same are disclosed. The display panel includes gate lines, data lines, gate driver, and data driver. The gate lines and the data lines define multiple pixel areas. Each pixel electrode correspondingly connects with one gate line and one data line. Pixel areas connected with a same gate line allow lights having a same color to pass through. When displaying a picture, the gate driver sequentially drives the multiple gate lines, and the data driver applies a same gamma voltage on the pixel areas connected with the same gate line. The present invention can drive the display panel by a lower hardware cost such that light transmittance rates of sub-pixels corresponding to different colors when same grayscale voltages are applied are the same.

### BACKGROUND OF THE INVENTION

1. Field of the Invention

The present invention relates to a liquid crystal display technology field, and more particular to a display panel and a driving method for the same.

2. Description of Related Art

A display panel control liquid crystal molecules to tilt according to a received grayscale voltage in order to allow three color lights of red (R), green (G), and blue (B) to pass through so as to display a picture. When applying same grayscale voltages, wavelengths of the three color lights of RGB are different so that light transmittance rates are different. In order to ensure a white balance (white tracking) of a displayed picture, gamma curves (curve of grayscale voltage to transmittance rate) corresponding to the three color lights have to be adjusted such that when applying the same grayscale voltages, light transmittance rates of the three color lights are the same.

In the conventional technology solution, a white balance (white tracking) module of a timing control chip (IC, TCON) is utilized to adjust the gamma curves corresponding to three color lights of RGB through an algorithm. Actually, the above method adjusts each sub-pixel corresponding to the three color lights of RGB. For example, when a display picture has 256 grayscales, 3×256 grayscale voltages are required to apply to all sub-pixels corresponding to the three color lights of RGB. That is, 3×256 storage units are required to store regulation values of the grayscale voltages corresponding to the three color lights. The cost of hardware is higher.

### SUMMARY OF THE INVENTION

Accordingly, the embodiment of the present invention provides a display panel and a driving method, which can drive the display panel by a lower hardware cost such that when applying a same grayscale voltage, light transmittance rates of sub-pixels corresponding to three color lights of RGB are the same.

One embodiment of the present invention provides a display panel. The display panel comprising: multiple gate lines disposed long a predetermined direction and disposed at intervals; a gate driver for driving the multiple gate lines; multiple data lines isolated and intersected with the multiple gate lines; a data driver for driving the multiple data lines; and a timing controller; wherein, the multiple gate lines and the multiple data lines define multiple pixel areas; each pixel area includes a thin film transistor (TFT) and a pixel electrode; each pixel electrode correspondingly connects with one of the multiple gate lines and one of the multiple data lines; wherein, pixel areas connected with a same gate line allow lights having a same color to pass through; gate electrodes of the TFTs are respectively connected with the gate lines; source electrodes of the TFTs are respectively connected with the data lines; drain electrodes of the TFTs are respectively connected with the pixel electrodes; and wherein, when displaying a picture, the gate driver sequentially drives the multiple gate lines; the data driver synchronously executes a grayscale driving action to the multiple data lines in order to apply a same gamma voltage on the pixel areas connected with the same gate line; within a blanking period that the gate driver drives two adjacent gate lines, the timing controller informs the gate driver to apply the gamma voltage on pixel areas connected with a following gate line.

Another embodiment of the present invention provides a display panel. The display panel, comprising: multiple gate lines disposed long a predetermined direction and disposed at intervals; a gate driver for driving the multiple gate lines; multiple data lines isolated and intersected with the multiple gate lines; and a data driver for driving the multiple data lines; wherein, the multiple gate lines and the multiple data lines define multiple pixel areas; each pixel area includes a thin film transistor (TFT) and a pixel electrode; each pixel electrode correspondingly connects with one of the multiple gate lines and one of the multiple data lines; wherein, pixel areas connected with a same gate line allow lights having a same color to pass through; and wherein, when displaying a picture, the gate driver sequentially drives the multiple gate lines; the data driver apply a same gamma voltage on the pixel areas connected with the same gate line.

Wherein, an I2C (inter-integrated circuit) bus is connected between the timing controller and the data driver.

Wherein, the pixel areas connected with each gate line sequentially allow a red color light, a green color light, and a blue color light to pass through, and cyclically repeated along a direction which is in parallel the data lines.

Another embodiment of the present invention provides a driving method for a display panel. The display panel includes multiple gate lines disposed long a predetermined direction and disposed at intervals, a gate driver for driving the multiple gate lines, multiple data lines isolated and intersected with the multiple gate lines, and a data driver for driving the multiple data lines; the multiple gate lines and the multiple data lines define multiple pixel areas; each pixel area is correspondingly connected with one of the multiple gate lines and one of the multiple data lines; pixel areas connected with a same gate line allow lights having a same color to pass through, and the driving method comprises: the gate driver sequentially drives the multiple gate lines; and the data driver applies a same gamma voltage on the pixel areas connected with a same gate line.

Wherein, the display panel further includes a timing controller; within a blanking period that the gate driver drives two adjacent gate lines, the timing controller informs the gate driver to apply the gamma voltage on pixel areas connected with a following gate line.

Wherein, an I2C (inter-integrated circuit) bus is connected between the timing controller and the data driver.

Wherein, the pixel areas connected with each gate line sequentially allow a red color light, a green color light, and a blue color light to pass through, and cyclically repeated along a direction which is in parallel the data lines.

Wherein, the display panel further includes a thin film transistor (TFT) and a pixel electrode connected with each pixel area; gate electrodes of the TFTs are respectively connected with the gate lines; source electrodes of the TFTs are respectively connected with the data lines; drain electrodes of the TFTs are respectively connected with the pixel electrodes; when the gate driver sequentially drives the multiple gate lines, the data driver synchronously executes a grayscale driving action to the multiple data lines in order to apply the same gamma voltage on the pixel areas connected with the same gate line.

The display panel and the driving method of the embodiment of the present invention design that pixel areas connected with a same gate line to allow lights having a same color to pass through. When driving, multiple pixel areas connected with a same gate line can be applied on a same gamma voltage. Respectively applying grayscale voltages to pixel areas is not required such that storage units for storing regulation values of grayscale voltages corresponding to three color lights of RGB are reduced. The cost of hardware is lower.

### BRIEF DESCRIPTION OF THE DRAWINGS

FIG. 1 is a schematic diagram of a pixel structure of a display panel according to an embodiment of the present invention;

FIG. 2 is a schematic diagram of a driving circuit of a display panel according to an embodiment of the present invention; and

FIG. 3 is a flow chat of a driving method according to an embodiment of the present invention.

### DETAILED DESCRIPTION OF THE PREFERRED EMBODIMENT

The following content combines figures and embodiments for detail description of the present invention.

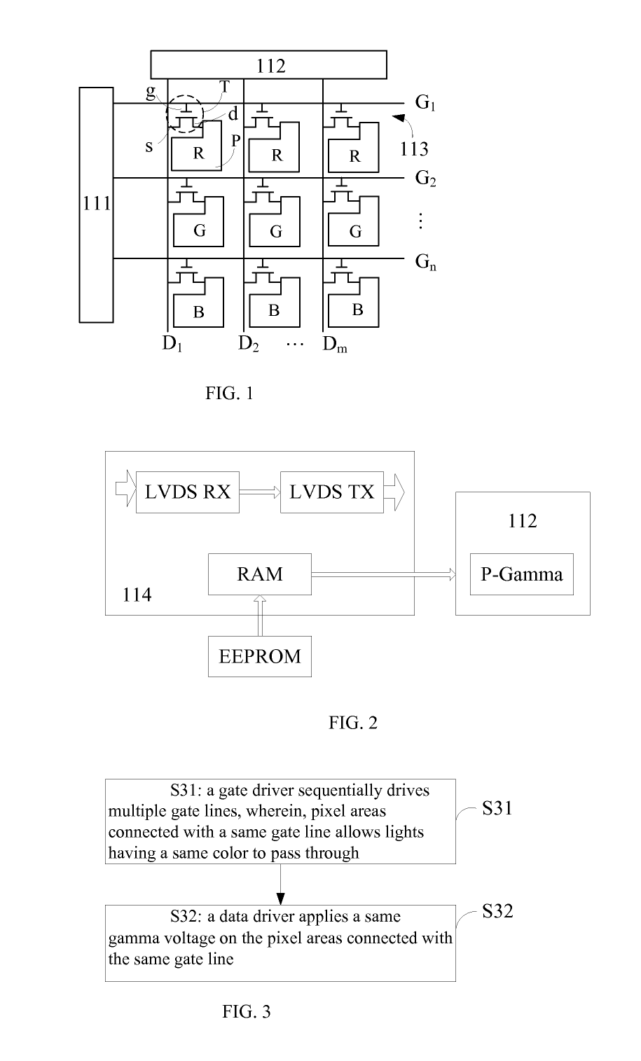

FIG. 1 is a schematic diagram of a pixel structure of a display panel according to an embodiment of the present invention. As shown in FIG. 1, the display panel (such as a liquid crystal display panel) includes a gate driver 111, a data driver 112, multiple gate lines G₁, G₂, . . . , Gₙ which are disposed long a predetermined direction and disposed at intervals, and multiple data lines D₁, D₂, . . . , Dₘ isolated and intersected with the multiple gate lines G₁, G₂, . . . , Gₙ. Wherein, the multiple gate lines G₁, G₂, . . . , Gₙ and the multiple data lines D₁, D₂, . . . , Dₘ define multiple pixel areas 113 arranged as a matrix.

Each pixel area 113 is correspondingly connected with a gate line and a data line. Each pixel area 113 includes a thin film transistor (TFT) T and a pixel electrode P. The pixel electrode P and a common electrode of the display panel are disposed oppositely. The thin film transistor T includes a gate electrode g, a source electrode s, and a drain electrode d. Wherein, the pixel electrode P is correspondingly connected with the drain electrode d. The gate line is correspondingly connected with the gate electrode g. The data line is correspondingly connected with the source electrode s. When the thin film transistor T is turned on, a data driving signal is transmitted to a corresponding pixel electrode P through the source electrode s.

The gate driver 111 sequentially provides a gate driving signal to the multiple gate lines G₁, G₂, . . . Gₙ in order to sequentially execute a gate driving action to the multiple gate lines G₁, G₂, . . . , Gₙ. Besides, the gate driver 111 also turns on a thin film transistor T corresponding to each gate lines. The data driver 112 provides grayscale driving signals (grayscale voltages) to the multiple data lines D₁, D₂, . . . , Dₘ in order to sequentially execute grayscale driving actions to the multiple data lines D₁, D₂, . . . , Dₘ such that the grayscale driving signals are applied to corresponding pixel electrodes P through the thin film transistors T which are turned on. Wherein, when the gate driver 111 executes the gate driving action, the data driver 112 synchronously executes a grayscale driving action to the data lines.

A same gate line correspondingly drives multiple pixel areas 113. When the gate line transmits a gate driving signal, the thin film transistors T driven by the same gate line are all turned on, and the multiple data lines D₁, D₂, . . . , Dₘ simultaneously transmit the grayscale driving signals to corresponding pixel electrodes P in order to charge the pixel electrodes P of the pixel areas 113 which display different colors.

In the present embodiment, multiple pixel areas 113 connected with a same gate line allow lights having a same color to pass through. For example, as shown in FIG. 1, pixel areas 113 connected with a gate line G₁ allow a red color light to pass through, pixel areas 113 connected with a gate line G₂ allow a green color light to pass through, and pixel areas 113 connected with a gate line G₃ allow a blue color light to pass through. Besides, the above arrangement way is cyclically repeated along a direction which is in parallel the data line, that is, along a column direction.

FIG. 2 is a schematic diagram of a driving circuit of a display panel according to an embodiment of the present invention. Combined with reference to FIG. 2, the display panel further includes a timing controller 114. A driving circuit of the display panel includes the timing controller 114, the data driver 112, and the gate driver 111. Between the timing controller 114 and the data driver 112, an I2C bus (Inter—Integrated Circuit, two lines serial bus) is provided for connection. When the display panel is displaying a picture, and within a blanking period that the gate driver 111 drives two adjacent gate lines, the timing controller 114 inform the gate driver 111 to apply a gamma voltage at a pixel areas 113 connected with a following gate line. Wherein, the gamma voltage is equal to a grayscale voltage applied on sub-pixels corresponding to three color lights of red (R), green (G), and blue (B).

Specifically, with reference to FIG. 1, previously, a gamma code (a program code) of a gamma voltage applied on sub-pixels corresponding to the three color lights of RGB applied by the data driver 112 is written to an EEPROM (Electrically Erasable Programmable Read-Only Memory). After the driver circuit is turned on, the timing controller 114 reads the gamma code, and store the gamma code into a RAM (Random Access Memory) of a timing controller 114. Within a blanking period that the gate driver 111 drives two adjacent gate lines, the timing controller 114 transmits the gamma code corresponding to a color to a programmable gamma voltage generation chip (P-Gamma) of the data driver 112 through the I2C bus in order to generate a gamma voltage applied on sub-pixels in a row direction.

For example, when the thin film transistors T connected with the gate line G₁ of the first row are turned on, and within a blanking period before charging the pixel electrodes P connected with the gate line G₁, the timing controller 114 transmits a gamma code corresponding to a red sub-pixel to the programmable gamma voltage generation chip (P-Gamma) of the data driver 112 through the I2C bus. The programmable gamma voltage generation chip (P-Gamma) generates a gamma voltage required by the red sub-pixel. The gamma voltage is used as a digital reference voltage of a digital-to-analog converter (DAC) inside the data driver 112. After the data driver 112 receives a data signal transmitted from the timing controller 114, through the digital-to-analog converter, a corresponding analog voltage is generated to charge the pixel electrodes P connected with the gate line G₁.

Of course, the timing controller 114 of the present embodiment also provides a low-voltage-differential-signal reception terminal (LVDS RX) and low-voltage-differential-signal transmission terminal (LVDS TX) in order to transmit related signals.

Because the pixel areas 113 connected with the same gate line allow lights having a same color to pass through, when the display panel of the present embodiment is driving, a same gamma voltage is applied at the multiple pixel areas 113 connected with the same gate line. Respectively applying gamma voltages to pixel areas 113 is not required so that a storage unit (that is, a white balance storage device) for storing regulation values of grayscale voltages corresponding to three color lights of RGB in the conventional art is not required. Accordingly, the hardware cost is lower. Besides, in the conventional art, the P-Gamma and the data driver are disposed separately. However, in the present embodiment, the P-Gamma is disposed inside the data driver 112 so that the number of the elements on a timing control board is reduced in order to decrease the cost.

FIG. 3 is a flow chat of a driving method according to an embodiment of the present invention. The driving method is used for driving the display panel having the pixel structure shown in FIG. 1 in order to regulate gamma curves corresponding to three color lights of RGB such that when applying a same grayscale voltage, light transmittance rates of sub-pixels corresponding to three color lights of RGB are the same. As shown in FIG. 3, the driving method includes:

Step S31: a gate driver sequentially drives multiple gate lines, wherein, pixel areas connected with a same gate line allows lights having a same color to pass through.

Step S32: a data driver applies a same gamma voltage on the pixel areas connected with the same gate line.

The driving method of the present embodiment can be correspondingly executed through the elements of the display panel described above. The specifically process can refer to the above driving process.

In summary, the core purpose of the embodiment of the present invention is to design that pixel areas connected with a same gate line allow lights having a same color to pass through. When driving, multiple pixel areas connected with a same gate line can be applied on a same gamma voltage. Respectively applying grayscale voltages to pixel areas is not required such that storage units for storing regulation values of grayscale voltages corresponding to three color lights of RGB are reduced. The cost of hardware is lower.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A display panel, comprising:
multiple gate lines disposed long a predetermined direction and disposed at intervals;
a gate driver for driving the multiple gate lines;
multiple data lines isolated and intersected with the multiple gate lines;
a data driver for driving the multiple data lines; and
a timing controller;
wherein, the multiple gate lines and the multiple data lines define multiple pixel areas; each pixel area includes a thin film transistor (TFT) and a pixel electrode; each pixel electrode correspondingly connects with one of the multiple gate lines and one of the multiple data lines;
wherein, pixel areas connected with a same gate line allow lights having a same color to pass through; gate electrodes of the TFTs are respectively connected with the gate lines; source electrodes of the TFTs are respectively connected with the data lines; drain electrodes of the TFTs are respectively connected with the pixel electrodes; and
wherein, when displaying a picture, the gate driver sequentially drives the multiple gate lines; the data driver synchronously executes a grayscale driving action to the multiple data lines in order to apply a same gamma voltage on the pixel areas connected with the same gate line; within a blanking period that the gate driver drives two adjacent gate lines, the timing controller informs the gate driver to apply the gamma voltage on pixel areas connected with a following gate line.

2. The display panel according to claim 1, wherein, an I2C (inter-integrated circuit) bus is connected between the timing controller and the data driver.

3. The display panel according to claim 1, wherein, the pixel areas connected with each gate line sequentially allow a red color light, a green color light, and a blue color light to pass through, and cyclically repeated along a direction which is in parallel the data lines.

4. A display panel, comprising:
multiple gate lines disposed long a predetermined direction and disposed at intervals;
a gate driver for driving the multiple gate lines;
multiple data lines isolated and intersected with the multiple gate lines; and
a data driver for driving the multiple data lines;
wherein, the multiple gate lines and the multiple data lines define multiple pixel areas; each pixel area includes a thin film transistor (TFT) and a pixel electrode; each pixel electrode correspondingly connects with one of the multiple gate lines and one of the multiple data lines;
wherein, pixel areas connected with a same gate line allow lights having a same color to pass through; and
wherein, when displaying a picture, the gate driver sequentially drives the multiple gate lines; the data driver applies a same gamma voltage on the pixel areas connected with the same gate line.

5. The display panel according to claim 4, wherein, the display panel further includes a timing controller, and within a blanking period that the gate driver drives two adjacent gate lines, the timing controller informs the gate driver to apply the gamma voltage on pixel areas connected with a following gate line.

6. The display panel according to claim 5, wherein, an I2C (inter-integrated circuit) bus is connected between the timing controller and the data driver.

7. The display panel according to claim 4, wherein, the pixel areas connected with each gate line sequentially allow a red color light, a green color light, and a blue color light to pass through, and cyclically repeated along a direction which is in parallel the data lines.

8. The display panel according to claim 4, wherein, the display panel further includes a thin film transistor (TFT) and a pixel electrode connected with each pixel area; gate electrodes of the TFTs are respectively connected with the gate lines; source electrodes of the TFTs are respectively connected with the data lines; drain electrodes of the TFTs are respectively connected with the pixel electrodes; when the gate driver sequentially drives the multiple gate lines, the data driver synchronously executes a grayscale driving action to the multiple data lines in order to apply a same gamma voltage on the pixel areas connected with the same gate line.

9. A driving method for a display panel, wherein, the display panel includes multiple gate lines disposed long a predetermined direction and disposed at intervals, a gate driver for driving the multiple gate lines, multiple data lines isolated and intersected with the multiple gate lines, and a data driver for driving the multiple data lines; the multiple gate lines and the multiple data lines define multiple pixel areas; each pixel area is correspondingly connected with one of the multiple gate lines and one of the multiple data lines; pixel areas connected with a same gate line allow lights having a same color to pass through, and the driving method comprises:
the gate driver sequentially drives the multiple gate lines; and
the data driver applies a same gamma voltage on the pixel areas connected with a same gate line.

10. The driving method according to claim 9, wherein, the display panel further includes a timing controller; within a blanking period that the gate driver drives two adjacent gate lines, the timing controller informs the gate driver to apply the gamma voltage on pixel areas connected with a following gate line.

11. The driving method according to claim 10, wherein, an I2C (inter-integrated circuit) bus is connected between the timing controller and the data driver.

12. The driving method according to claim 10, wherein, the pixel areas connected with each gate line sequentially allow a red color light, a green color light, and a blue color light to pass through, and cyclically repeated along a direction which is in parallel the data lines.

13. The driving method according to claim 10, wherein, the display panel further includes a thin film transistor (TFT) and a pixel electrode connected with each pixel area; gate electrodes of the TFTs are respectively connected with the gate lines; source electrodes of the TFTs are respectively connected with the data lines; drain electrodes of the TFTs are respectively connected with the pixel electrodes; when the gate driver sequentially drives the multiple gate lines, the data driver synchronously executes a grayscale driving action to the multiple data lines in order to apply the same gamma voltage on the pixel areas connected with the same gate line.
